(19) United States
(12) Patent Application Publication
(10) Pub. No.: US 2022/0356754 A1
(43) Pub. Date: Nov. 10, 2022

(54) MULTI-DIRECTIONAL OPENING FLAP PET DOOR

(71) Applicant: Yu Lou, Ningbo (CN)

(72) Inventor: Yu Lou, Ningbo (CN)

(21) Appl. No.: 17/870,849

(22) Filed: Jul. 22, 2022

(51) Int. Cl. E06B 7/32

(52) U.S. Cl. CPC E06B 7/32

(57) ABSTRACT

The present invention provides a multi-directional opening flap pet door, relating to the technical field of pet bearing devices, which comprises: a supporting door frame, a bearing door frame, a locking seat and a blocking door panel. When a locking column slides into a bidirectional locking hole, the blocking door panel is locked bidirectionally, and when the locking column slides into an entrance-exit sliding hole, the blocking door panel is open bidirectionally. It solves the problem that most of the pet doors currently rotate in one direction, and the pet door needs to be adjusted manually, which limits the applicability of pet boxes or pet cages for pet bearing.

### TECHNICAL FIELD

The present invention relates to the technical field of pet bearing devices, and more particularly to a multi-directional opening flap pet door.

### BACKGROUND

Pets refer to creatures that are kept by a person for spiritual purposes, not for economic purposes. Traditional pets refer to mammals or birds, kept for enjoyment and companionship. Pets in real life include fish, reptiles, amphibians, insects, and even plants. A pet box or pet cage is used when the pet is raised.

However, the pet doors used in most pet boxes or pet cages are mostly set with one-way rotation. Therefore, when pets enter and exit the pet box or pet cage, the pet door needs to be manually adjusted, limiting the applicability of the pet box or pet cage for bearing pets.

### SUMMARY

In view of the above, the present invention provides a multi-directional opening flap pet door having a multi-directional locking structure and a blocking door panel, and a multi-directional supporting structure, thereby solving the problem that most pet doors currently rotate in one direction, and the pet door needs to be adjusted manually, which limit the applicability of pet boxes or pet cages for pet bearing.

The present invention provides a multi-directional opening flap pet door, comprising: a supporting door frame, a bearing door frame, a locking seat, and a blocking door panel;

wherein one side of the supporting door frame is fixedly mounted with an inlet cushion block, and the other side of the supporting door frame is fixedly mounted with an outlet cushion block; the bearing door frame is fixedly mounted on an inner side of the supporting door frame; a bearing groove is provided on the top of an inner side of the bearing door frame; a supporting column is mounted on an inner side of the bearing groove; the locking seat is fixedly mounted on the bottom of the inner side of the bearing door frame; an assembly groove is provided on an inner side of the locking seat; a multi-directional locking structure is provided on an inner side of the assembly groove; the multi-directional locking structure comprises an assembly sliding column; a sliding cylinder is sheathed on an outer side of the assembly sliding column; a positioning and locking structure is provided on a side of the locking seat and the assembly sliding column; the positioning and locking structure comprises a sliding strut; the sliding strut is fixedly mounted on a side surface of the sliding cylinder; the blocking door panel is provided on the inner side of the bearing door frame; assembly blocks are fixedly mounted at two ends of the top of the blocking door panel; a multi-directional supporting structure is arranged at the bottom of the blocking door panel; the multi-directional supporting structure comprises a displacement chute; and the displacement chute is provided at the bottom of the blocking door panel.

Further, the supporting door frame is further provided with a mounting supporting frame, locking blocks, and locking holes; and

wherein the mounting supporting frame is fixedly mounted on the outer side of one end of the supporting door frame; the locking blocks are fixedly mounted at four corners of one end of the supporting door frame; a locking hole penetrates through the sides of the locking block.

Further, the bearing door frame is further provided with a bearing block and an assembly spindle; and

wherein the bearing block is fixedly mounted on a side of the supporting column; the assembly spindle is rotatably mounted inside the bearing block; the assembly spindle fixedly interfaces with the assembly block.

Further, the locking seat further comprises a sliding slot and locking frames; and

wherein the sliding slot runs through a side face of the assembly groove; the locking frames are fixedly installed at both ends of a side face of the locking seat.

Further, the multi-directional locking structure further comprises a supporting block and a locking column; and

wherein the supporting block is fixedly mounted on the top of the sliding cylinder; the support block is arranged inside the assembly groove; the locking column is fixedly installed on the top of the support block.

Further, the positioning and locking structure further comprises a locking thread, a locking screw cylinder, and a rotary holding block; and

wherein the locking thread is provided outside one end of the sliding strut; the locking screw cylinder is sheathed outside the sliding strut; the rotary holding block is fixedly mounted to one end of the locking screw cylinder.

Further, the blocking door panel is further provided with an assembly chute, a transparent panel, and preset holes; and

wherein the assembly chute runs through a side face of the blocking door panel; the transparent panel is mounted on an inner side of the assembly chute; the preset hole penetrates through the sides of the transparent panel.

Further, the multi-directional supporting structure further comprises a bidirectional locking hole, an entrance-exit sliding hole, an exit locking hole, and an entrance locking hole; and

wherein the bidirectional locking hole is provided at the bottom of the blocking door panel; the entrance-exit sliding hole is provided at the bottom of the blocking door panel; the exit locking hole is provided at the bottom of the blocking door panel; the entrance locking hole is provided at the bottom of the blocking door panel, and the entrance locking hole is in communication with the exit locking hole, the entrance-exit sliding hole, and the bidirectional locking hole via a displacement chute.

### Advantageous Effects

The multi-directional opening flap pet door according to embodiments of the present invention is more adaptable for use than conventional pet doors.

In addition, the ventilation and blocking can be performed by the blocking door panel in cooperation with the transparent panel and the preset holes. At the same time, holding the rotary holding block can push and adjust the sliding strut for the displacement of the sliding cylinder, and can drive the locking column to slide laterally in the displacement chute. When the locking column slides into the bidirectional locking hole, the blocking door panel is bidirectionally locked so that the blocking door panel cannot be opened from both the inside and the outside. When the locking column slides into the entrance-exit sliding hole, the blocking door panel is bidirectionally opened so that the blocking door panel can be opened from both the inside and the outside. When the locking column slides into the exit locking hole, the blocking door panel is unidirectionally opened, so that the blocking door panel can be opened from the outside but not from the inside. When the locking column slides into the entrance locking hole, the blocking door panel is unidirectionally opened, so that the blocking door panel can be opened from the inside but not from the outside.

In addition, the supporting door frame can be fixedly mounted by the mounting supporting frame in cooperation with the locking blocks and the locking holes, the bearing block in cooperation with the assembly spindle, the blocking door panel can be rotatably mounted bidirectionally. The rotary holding block can rotatably lock the locking screw cylinder so that the locking screw cylinder is in cooperation with the locking frames. The sliding cylinder and the locking column can be positioned and locked, thereby stably locking the blocking door panel multi-directionally.

### BRIEF DESCRIPTION OF DRAWINGS

FIG. 1 is a front structural schematic diagram of an overall assembly of a device according to an embodiment of the present invention;

FIG. 2 is a side structural schematic diagram of an overall assembly of a device according to an embodiment of the present invention;

FIG. 3 is a front structural schematic diagram of an overall unfolding of a device according to an embodiment of the present invention;

FIG. 4 is a side structural schematic diagram of an overall unfolding of a device according to an embodiment of the present invention;

FIG. 5 is a structural schematic diagram of the assembly of a supporting door frame according to an embodiment of the present invention;

FIG. 6 is a structural schematic diagram of the assembly of a bearing door frame according to an embodiment of the present invention;

FIG. 7 is a structural schematic diagram of the assembly of a locking seat according to an embodiment of the present invention; and

FIG. 8 is a structural schematic diagram of the assembly of a blocking door panel according to an embodiment of the present invention;

### DETAILED DESCRIPTION OF THE EMBODIMENTS

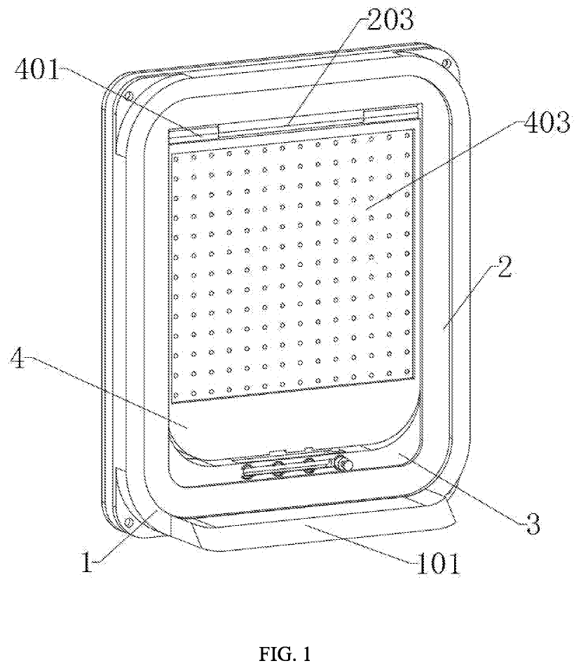

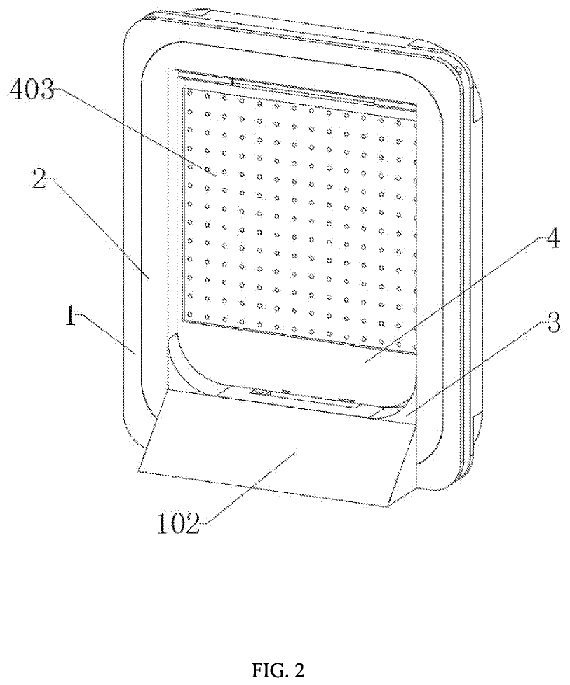

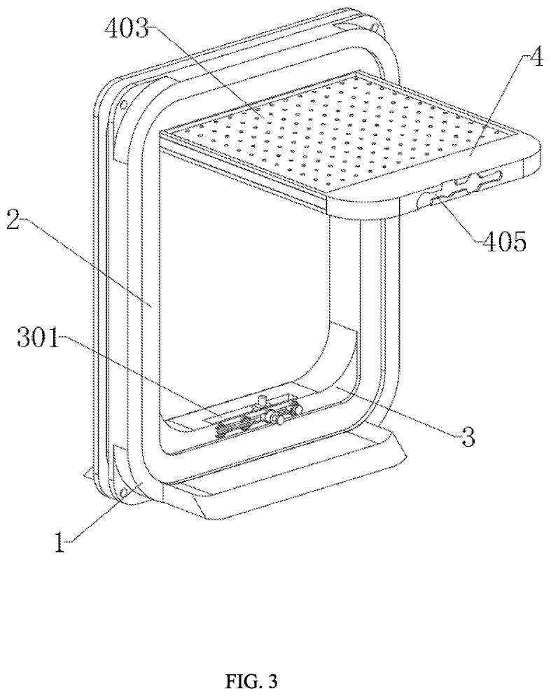

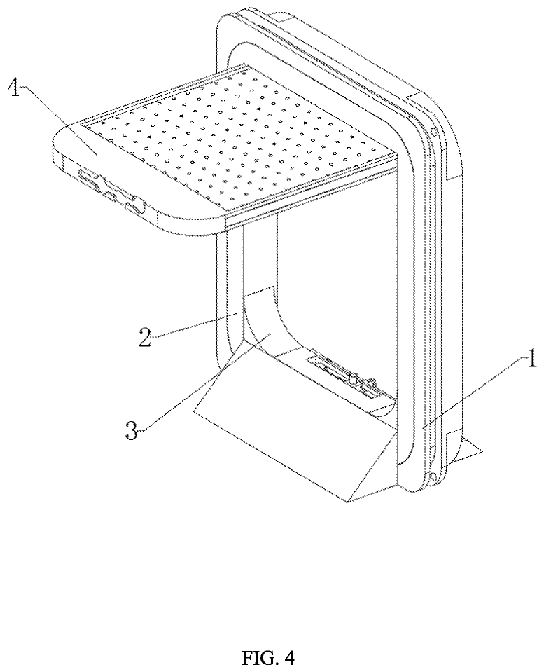

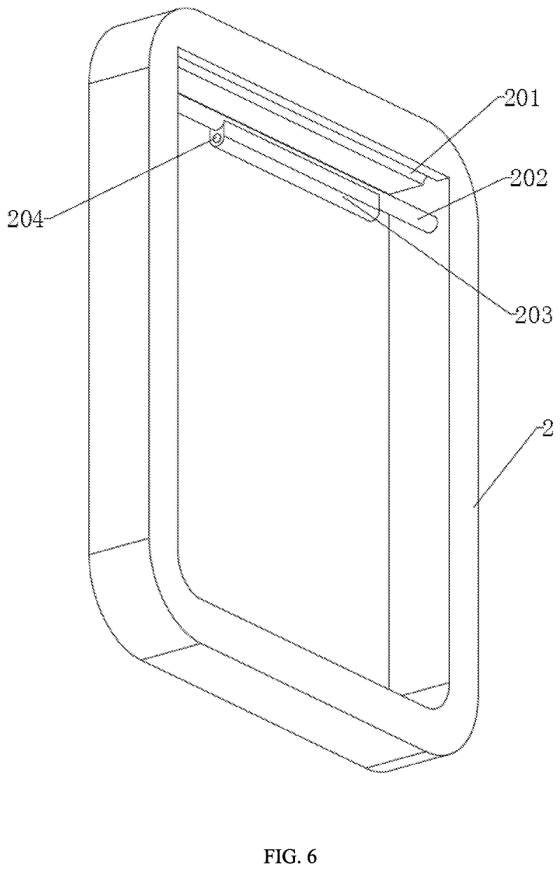

Embodiments: reference is made to FIGS. 1 to 8:

The present invention provides a multi-directional opening flap pet door comprising a supporting door frame 1, a bearing door frame 2, a locking seat 3, and a blocking door panel 4.

One side of the supporting door frame 1 is fixedly mounted with an inlet cushion block 101, and the other side of the supporting door frame 1 is fixedly mounted with an outlet cushion block 102. The bearing door frame 2 is fixedly mounted on an inner side of the supporting door frame 1. A bearing groove 201 is provided on the top of an inner side of the bearing door frame 2. A supporting column 202 is mounted on an inner side of the bearing groove 201. The locking seat 3 is fixedly mounted on the bottom of the inner side of the bearing door frame 2. An assembly groove 301 is provided on an inner side of the locking seat 3. A multi-directional locking structure is provided on an inner side of the assembly groove 301. The multi-directional locking structure comprises an assembly sliding column 304. A sliding cylinder 3041 is sheathed on an outer side of the assembly sliding column 304. A positioning and locking structure is provided on a side of the locking seat 3 and the assembly sliding column 304. The positioning and locking structure comprises a sliding strut 305. The sliding strut 305 is fixedly mounted on a side surface of the sliding cylinder 3041. The blocking door panel 4 is provided on the inner side of the bearing door frame 2. Assembly blocks 401 are fixedly mounted at two ends of the top of the blocking door panel 4. A multi-directional supporting structure is arranged at the bottom of the blocking door panel 4. The multi-directional supporting structure comprises a displacement chute 405. The displacement chute 405 is provided at the bottom of the blocking door panel 4.

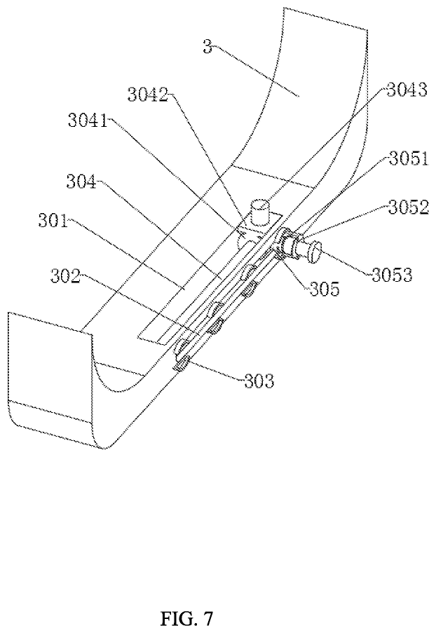

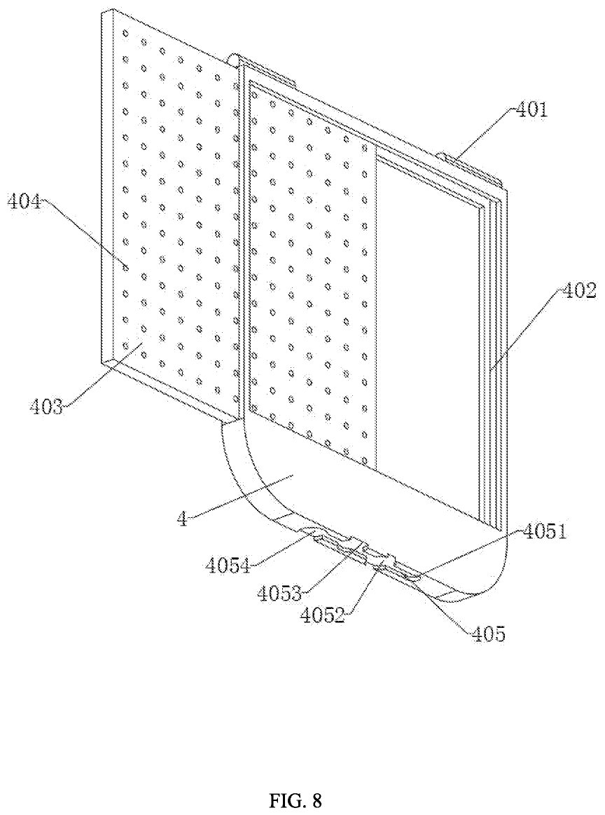

As shown in FIGS. 7 and 8, the multi-directional locking structure further comprises a supporting block 3042 and a locking column 3043. The supporting block 3042 is fixedly mounted on the top of the sliding cylinder 3041. The support block 3042 is arranged inside the assembly groove 301. The locking column 3043 is fixedly installed on top of the support block 3042. The positioning and locking structure further comprises a locking thread 3051, a locking screw cylinder 3052, and a rotary holding block 3053. The locking thread 3051 is provided outside one end of the sliding strut 305. The locking screw cylinder 3052 is sheathed outside the sliding strut 305. The rotary holding block 3053 is fixedly mounted to one end of the locking screw cylinder 3052. The blocking door panel 4 is further provided with an assembly chute 402, a transparent panel 403, and preset holes 404. The assembly chute 402 runs through a side face of the blocking door panel 4. The transparent panel 403 is mounted on an inner side of the assembly chute 402. The preset hole 404 penetrates through the sides of the transparent panel 403. The multi-directional supporting structure further comprises a bidirectional locking hole 4051, an entrance-exit sliding hole 4052, an exit locking hole 4053, and an entrance locking hole 4054. The bidirectional locking hole 4051 is provided at the bottom of the blocking door panel 4. The entrance-exit sliding hole 4052 is provided at the bottom of the blocking door panel 4. The exit locking hole 4053 is provided at the bottom of the blocking door panel 4. The entrance locking hole 4054 is provided at the bottom of the blocking door panel 4. The entrance locking hole 4054 is in communication with the exit locking hole 4053, the entrance-exit sliding hole 4052, and the bidirectional locking hole 4051 via a displacement chute 405. In addition, the ventilation and blocking can be performed by the blocking door panel 4 in cooperation with the transparent panel 403 and the preset holes 404. At the same time, holding the rotary holding block 3053 can push and adjust the sliding strut 305 for the displacement of the sliding cylinder 3041 and can drive the locking column 3043 to slide laterally in the displacement chute 405. When the locking column 3043 slides into the bidirectional locking hole 4051, the blocking door panel 4 is bidirectionally locked so that the blocking door panel 4 cannot be opened from both the inside and the outside. When the locking column 3043 slides into the entrance-exit sliding hole 4052, the blocking door panel 4 is bidirectionally opened so that the blocking door panel 4 can be opened from both the inside and the outside. When the locking column 3043 slides into the exit locking hole 4053, the blocking door panel 4 is unidirectionally opened so that the blocking door panel 4 can be opened from the outside but not from the inside. When the locking column 3043 slides into the entrance locking hole 4054, the blocking door panel 4 is unidirectionally opened, so that the blocking door panel 4 can be opened from the inside but not from the outside.

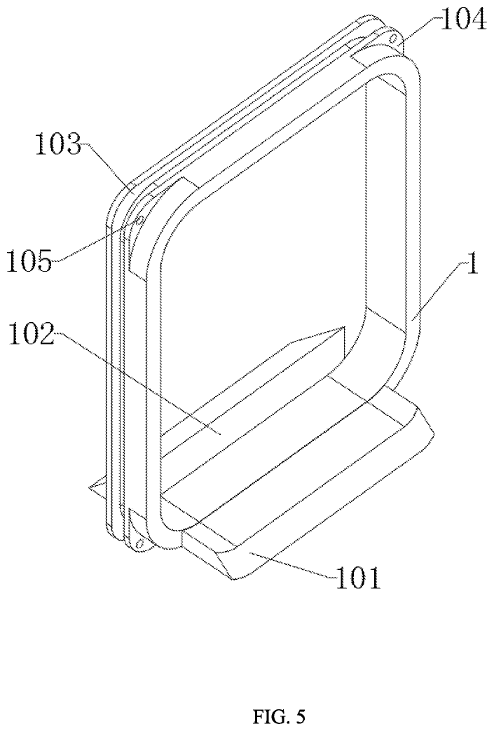

As shown in FIGS. 5 to 8, the supporting door frame 1 is further provided with a mounting supporting frame 103, locking blocks 104, and locking holes 105. The mounting supporting frame 103 is fixedly mounted on the outer side of one end of the supporting door frame 1. The locking blocks 104 are fixedly mounted at four corners of one end of the supporting door frame 1. A locking hole 105 penetrates through the sides of the locking block 104. The bearing door frame 2 is further provided with a bearing block 203 and an assembly spindle 204. The bearing block 203 is fixedly mounted on a side of the supporting column 202. The assembly spindle 204 is rotatably mounted inside the bearing block 203. The assembly spindle 204 fixedly interfaces with the assembly block 401. The locking seat 3 further comprises a sliding slot 302 and locking frames 303. The sliding slot 302 runs through a side face of the assembly groove 301. The locking frames 303 are fixedly installed at both ends of a side face of the locking seat 3. The supporting door frame 1 can be fixedly mounted by the mounting supporting frame 103 in cooperation with the locking blocks 104 and the locking holes 105, the bearing block 203 in cooperation with the assembly spindle 204, the blocking door panel 4 can be rotatably mounted bidirectionally. The rotary holding block 3053 can rotatably lock the locking screw cylinder 3052 so that the locking screw cylinder 3052 is in cooperation with the locking frames 303. The sliding cylinder 3041 and the locking column 3043 can be positioned and locked, thereby stably locking the blocking door panel 4 multi-directionally.

Specific modes of use and function of this embodiment: in the present invention, the supporting door frame 1 can be fixedly mounted by the mounting supporting frame 103 in cooperation with the locking blocks 104 and the locking holes 105, the bearing block 203 in cooperation with the assembly spindle 204, the blocking door panel 4 can be rotatably mounted bidirectionally. The ventilation and blocking can be performed by the blocking door panel 4 in cooperation with the transparent panel 403 and the preset holes 404. At the same time, holding the rotary holding block 3053 can push and adjust the sliding strut 305 for the displacement of the sliding cylinder 3041 and can drive the locking column 3043 to slide laterally in the displacement chute 405. The rotary holding block 3053 can rotate and lock the locking screw cylinder 3052, so that the locking screw cylinder 3052 can be in cooperation with the locking frames 303 to position and lock the sliding cylinder 3041 and the locking column 3043. When the locking column 3043 slides into the bidirectional locking hole 4051, the blocking door panel 4 is bidirectionally locked so that the blocking door panel 4 cannot be opened from both the inside and the outside. When the locking column 3043 slides into the entrance-exit sliding hole 4052, the blocking door panel 4 is bidirectionally opened so that the blocking door panel 4 can be opened from both the inside and the outside. When the locking column 3043 slides into the exit locking hole 4053, the blocking door panel 4 is unidirectionally opened so that the blocking door panel 4 can be opened from the outside but not from the inside. When the locking column 3043 slides into the entrance locking hole 4054, the blocking door panel 4 is unidirectionally opened, so that the blocking door panel 4 can be opened from the inside but not from the outside.

What is claimed is:

1. A multi-directional opening flap pet door, comprising: a supporting door frame (1), a bearing door frame (2), a locking seat (3), and a blocking door panel (4); and
wherein one side of the supporting door frame (1) is fixedly mounted with an inlet cushion block (101), and the other side of the supporting door frame (1) is fixedly mounted with an outlet cushion block (102); the bearing door frame (2) is fixedly mounted on an inner side of the supporting door frame (1); a bearing groove (201) is provided on the top of an inner side of the bearing door frame (2);
a supporting column (202) is mounted on an inner side of the bearing groove (201); the locking seat (3) is fixedly mounted on the bottom of the inner side of the bearing door frame (2); an assembly groove (301) is provided on an inner side of the locking seat (3); a multi-directional locking structure is provided on an inner side of the assembly groove (301); the multi-directional locking structure comprises an assembly sliding column (304); a sliding cylinder (3041) is sheathed on an outer side of the assembly sliding column (304); a positioning and locking structure is provided on a side of the locking seat (3) and the assembly sliding column (304); the positioning and locking structure comprises a sliding strut (305); the sliding strut (305) is fixedly mounted on a side surface of the sliding cylinder (3041); the blocking door panel (4) is provided on the inner side of the bearing door frame (2); assembly blocks (401) are fixedly mounted at two ends of the top of the blocking door panel (4); a multi-directional supporting structure is arranged at the bottom of the blocking door panel (4); the multi-directional supporting structure comprises a displacement chute (405); and the displacement chute (405) is provided at the bottom of the blocking door panel (4).

2. The multi-directional opening flap pet door of claim 1, wherein: the supporting door frame (1) is further provided with a mounting supporting frame (103), locking blocks (104), and locking holes (105); and
wherein the mounting supporting frame (103) is fixedly mounted on the outer side of one end of the supporting door frame (1); the locking blocks (104) are fixedly mounted at four corners of one end of the supporting door frame (1); a locking hole (105) penetrates through the sides of the locking block (104).

3. The multi-directional opening flap pet door of claim 1, wherein, the bearing door frame (2) is further provided with a bearing block (203) and an assembly spindle (204); and
wherein the bearing block (203) is fixedly mounted on a side of the supporting column (202); the assembly spindle (204) is rotatably mounted inside the bearing block (203); the assembly spindle (204) fixedly interfaces with the assembly block (401).

4. The multi-directional opening flap pet door of claim 1, wherein the locking seat (3) further comprises a sliding slot (302) and locking frames (303); and
wherein the sliding slot (302) runs through a side face of the assembly groove (301); the locking frames (303) are fixedly installed at both ends of a side face of the locking seat (3).

5. The multi-directional opening flap pet door of claim 1, wherein the multi-directional locking structure further comprises a supporting block (3042) and a locking column (3043); and
wherein the supporting block (3042) is fixedly mounted on the top of the sliding cylinder (3041); the support block (3042) is arranged inside the assembly groove (301); the locking column (3043) is fixedly installed on the top of the support block (3042).

6. The multi-directional opening flap pet door of claim 1, wherein the positioning and locking structure further comprises a locking thread (3051), a locking screw cylinder (3052), and a rotary holding block (3053); and
wherein the locking thread (3051) is provided outside one end of the sliding strut (305); the locking screw cylinder (3052) is sheathed outside the sliding strut (305); the rotary holding block (3053) is fixedly mounted to one end of the locking screw cylinder (3052).

7. The multi-directional opening flap pet door of claim 1, wherein the blocking door panel (4) is further provided with an assembly chute (402), a transparent panel (403), and preset holes (404); and
wherein the assembly chute (402) runs through a side face of the blocking door panel (4); the transparent panel (403) is mounted on an inner side of the assembly chute (402); the preset hole (404) penetrates through the sides of the transparent panel (403).

8. The multi-directional opening flap pet door of claim 1, wherein the multi-directional supporting structure further comprises a bidirectional locking hole (4051), an entrance-exit sliding hole (4052), an exit locking hole (4053), and an entrance locking hole (4054); and
wherein the bidirectional locking hole (4051) is provided at the bottom of the blocking door panel (4); the entrance-exit sliding hole (4052) is provided at the bottom of the blocking door panel (4); the exit locking hole (4053) is provided at the bottom of the blocking door panel (4); the entrance locking hole (4054) is provided at the bottom of the blocking door panel (4), and the entrance locking hole (4054) is in communication with the exit locking hole (4053), the entrance-exit sliding hole (4052), and the bidirectional locking hole (4051) via a displacement chute (405).
